(19) United States
(12) Patent Application Publication
(10) Pub. No.: US 2014/0247586 A1
(43) Pub. Date: Sep. 4, 2014

(54) Method for retrofitting and retrofit kit for gaming devices using F4T5 florescent internal lighting with LED lighting

(71) Applicant: John Cox Wall, Colorado Springs, CO (US)

(72) Inventor: John Cox Wall, Colorado Springs, CO (US)

(73) Assignee: Access Energy Solutions, LLC, Colorado Springs, CO (US)

(21) Appl. No.: 13/815,414

(22) Filed: Mar. 1, 2013

(51) Int. Cl. F21S 4/00; F21K 99/00; F21V 21/08

(52) U.S. Cl. CPC F21S 4/005; F21V 21/0808; F21K 9/17
USPC 362/217.17; 362/382

(57) ABSTRACT

A retrofit kit is provided for existing slot machines that include a lighting strip, electronic driver assembly, connectors and an installation procedure. The retrofit kit may include a variety of mounting hardware. The retrofit kit replaces existing florescent or incandescent lighting with LED lighting.

### REFERENCES CITED

U.S. Pat. No. 6,824,466 Azure 30 Nov. 2004

U.S. Pat. No. 5,667,439 universal sales 16 Sep. 1997

U.S. Pat. No. 6,705,611 Konami 16 Mar. 2004

U.S. Pat. No. 5,018,737 Kabushiki 28 May 1991

U.S. Pat. No. 6,159,097 WMS 12 Dec. 2000

U.S. Pat. No. 4,624,459 Bally 25 Nov. 1986

U.S. Pat. No. 6,605,000 IGT 12 Aug. 2003

U.S. Pat. No. 4,454,670 Coca Cola 19 Jun. 1984

U.S. Pat. No. 4,838,552 Sigma Enterprises, Incorporated 13 Jun. 1989

U.S. Pat. No. 6,056,642 Aristocrat 2 May 2000

U.S. Pat. No. 7,364,506 WMS 29 Apr. 2008

U.S. Pat. No. 5,902,184 Aristocrat 11 May 1999

### BACKGROUND OF THE INVENTION

Gaming devices presently use florescent tubes of varying sizes to provide illumination of various components visible to the user of the device. These light bulbs 9-11, fixtures 13-15, and power supply ballast 12 are installed as indicated on FIG. 2. Some devices have reflectors installed on the light fixtures described above.

Prior art florescent lighting fixtures of the type F4T5are of a mature and stable design. The availability of LED lighting solutions allows for a significantly more energy efficient solution to the lighting requirement. The difference between florescent lighting and LED lighting means that a direct replacement of existing bulbs with an LED bulb replacement is prohibitively expensive. Accordingly, the desire to use the more efficient LED lights has resulted in the development of a retrofit kit.

To keep the more efficient LED lighting attractive to the end user the costs associated with a retrofit need to be kept low. There is a need for retrofit kits which are low in cost and easy to install.

### SUMMARY OF THE INVENTION

A retrofit kit is provided for existing gaming devices that use F4T5florescent bulbs for internal lighting. The retrofit kit is comprised of a retrofit assembly consisting of LED lighting strips, a power supply (driver), and the necessary wires and connectors which install inside the existing device cabinet. The retrofit kit also contains accessories to ensure satisfactory installation and detailed installation instructions.

### BRIEF DESCRIPTION OF THE DRAWINGS

For a better understanding of the invention, reference is made to the accompanying drawings, which are incorporated herein by reference, and in which:

FIG. 1 is a perspective view of the elements of the retrofit assembly.

FIG. 2 is a perspective view of the prior art florescent lighting as installed in the devices.

FIG. 3 is a view of the interior of the relevant portions of a gaming device assembled without light reflectors, detailing the locations of installation of the retrofit kit for lighting without reflectors and disabling of the prior art florescent lighting for retirement in place.

FIG. 4 is a view of the interior of the relevant portions of a gaming device assembled with light reflectors, detailing the locations of installation of the retrofit kit for lighting with reflectors and disabling of the prior art florescent lighting for retirement in place.

### DETAILED DESCRIPTION

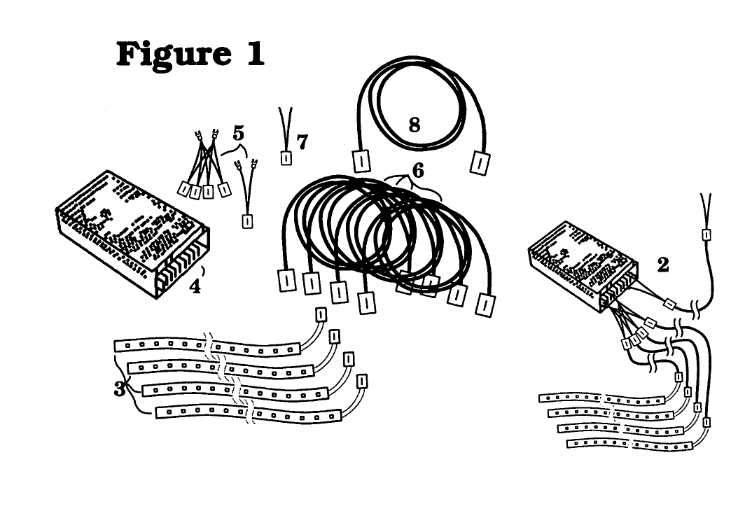

A retrofit kit 1 to replace existing F4T5florescent bulbs in the following gaming devices with strip LED lighting as shown in FIG. 1. The gaming devices to which this applies include the following:

Manufacturer: Aristocrat

Models: 540 Video, MAV500, ViRIDIANW, CROWN S

Manufacturer: Bally

Models: S63u3WT2, S6513WBF, S62M3WB, S63U4WBP, S653LWBF, S9-153-20, S9-1, AP-1, C9-1

Manufacturer: IGT

Models: 96450400, 96433300, 96424300, 96499412, QA65D, IA65C, 9640370R, 9640820R, 9640430R, 96419000, 96453500, 96438400, 96438300, 96442600, GD65D, 3770C, 96404900, 9640490R, 9643580R, 96418800, 96439900, 96418900. 96434900, 96433700, 96433600, ID79CF, ID65CF, S2,000, 96435800, 96435900, B5138CIW, B5138DIW, 96499304, 96453100, 96488300, 96409200, 96456600, 96418400, 96499203, 96499305, 96499809

Manufacturer: INN

Model: Video Slot

Manufacturer: KONAMI

Models: REVOLUTI, KGP2.0UV, KG12.0UR

Manufacturer: Western

Model: TXC/CXC

Manufacturer: WMS

Models: BBU, BB2, BBUR

And others using the F4T5bulb for illumination.

A retrofit assembly 2 includes a preassembled LED lighting strip 3 of up to 30 inches, a driver 4 to supply the LEDs with the required current, connectors 5 and 7 and conductors 6 and 8 to redirect power to the LED driver from the replaced florescent lights. This kit includes all parts required to replace the light source.

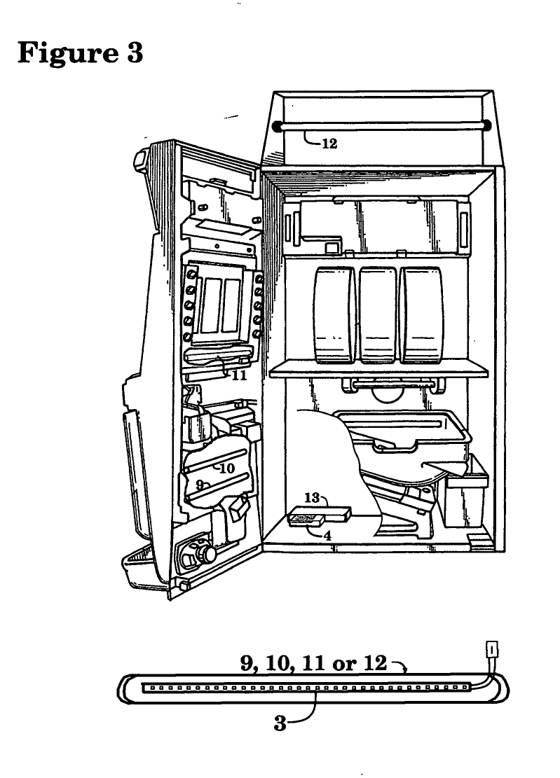

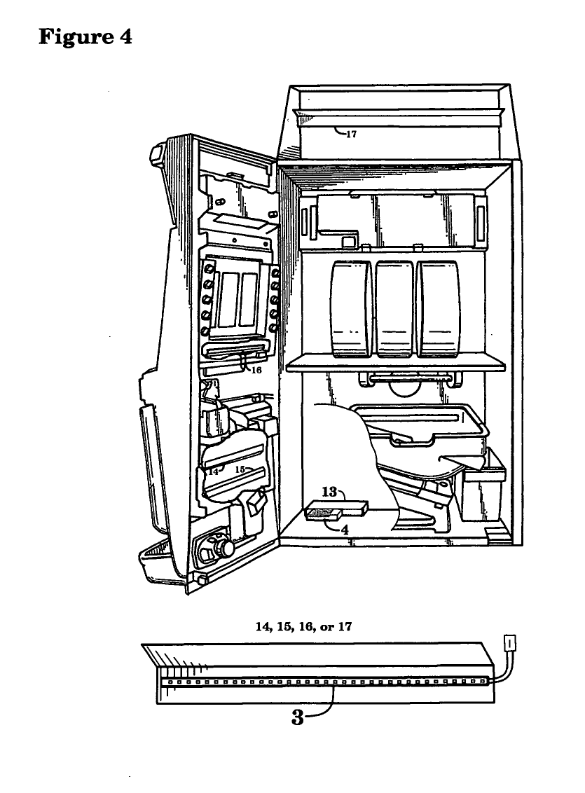

LED lighting strip 3 is a Non-Waterproof Flexible LED Strip, DC12V, SMD 3528, 60LEDs/m, 4.8 W/m, 6000-7000K, 310-330/foot, 120 degree beam angle or similar device between 2 and 7 inches in length and has an adhesive back for installation, and is installed as indicated in FIG. 3 or FIG. 4. The length can be adjusted at the factory or at the time of installation to customize for replaced tube length and for desired output light levels.

Driver 4 is a 15 Watt Power Supply (Driver); Output: 5V/9V/12V/24V/36V/48V with an aluminum Housing; Input Voltage, 86 v-265 v or similar device. The driver is connected to the LED strip light 3 as shown in FIG. 3 by means of connectors 5 and conductors 6, and connected to the machine light power supply by connector 7 and conductor 8. The driver housing is installed as indicated in FIG. 3 or FIG. 4 within the gaming device body.

Accessories included are alcohol wipes to clean surfaces prior to securing parts with adhesive strips.

The installation procedure for retrofitting an existing gaming device using the retrofit kit shown in FIG. 1 and described above is as follows:

Secure power to the device.

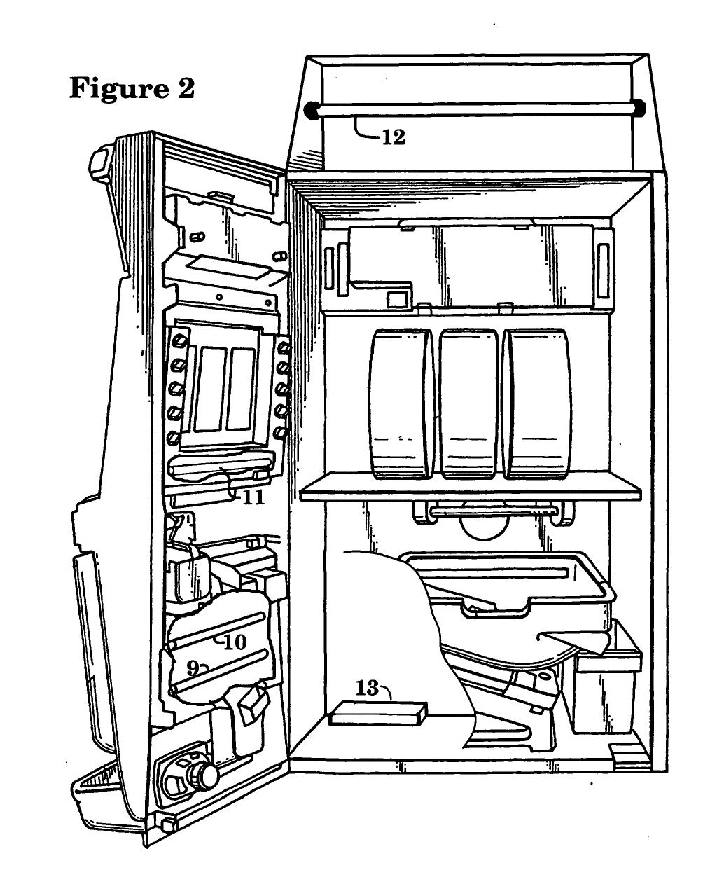

Locate and disconnect the power lines connected to the ballast 13 supplying the lights to be replaced as indicated in FIG. 2. The ballast and fixtures for the replaced lights will be retired in place. Connector 7 is connected to the power supply wires disconnected from the fixture to be replaced. Conductor 8 is routed to allow installation of the driver 4 housing as shown in FIG. 3 or 4.

Examine the bulbs 9-12 in FIG. 2 to be replaced.

If no reflector is installed, leave the bulbs 9-12 in place and clean the surface of the bulbs with the supplied alcohol wipe. Attach the desired length of LED lighting strip.3 directly to the bulb facing the area to be illuminated by means of the installed adhesive backing as shown in FIG. 3. Route the conductor 6 so as to connect the LED lighting strip 3 to the driver 4 by means of the quick connectors installed on connectors 5 and conductors 6.

If a reflector 14-17 is installed, remove the bulb and discard. Clean the reflector with the supplied wipe and attach the LED lighting strip 3 directly to the reflector on the side to be illuminated as shown in FIG. 4. Route the conductor 6 so as to connect the LED lighting strip 3 to the driver 4 by means of the quick connectors installed on connectors 5 and conductors 6.

What is claimed is:

1. A retrofit kit for internal florescent lighting in various machines and devices comprising:
A retrofit assembly; and
Accessories needed to support a successful installation, including detailed replacement instructions and cleaning materials.

2. A retrofit kit as described in claim 1, wherein said retrofit assembly is composed of an LED lighting strip, power supply (driver) with connectors to allow said lighting strip to be connected to said power supply (driver) and replace installed florescent lighting.

3. A retrofit kit as described in claim 1, wherein said retrofit kit provides a method and a retrofit assembly as described in claim 2 for replacement of F4T5florescent bulbs in gaming devices.

4. A retrofit kit as described in claim 1, wherein said retrofit kit provides a method and a retrofit assembly as described in claim 2 for replacement of F4T5florescent bulbs in these gaming devices:
Manufacturer: Aristocrat
Models: 540 Video, MAV500, ViRIDIANW, CROWN S
Manufacturer: Bally
Models: S63u3WT2, S6513WBF, S62M3WB, S63U4WBP, S653LWBF, S9-153-20, S9-1, AP-1, C9-1
Manufacturer: IGT
Models: 96450400, 96433300, 96424300, 96499412, QA65D, IA65C, 9640370R, 9640820R, 9640430R, 96419000, 96453500, 96438400, 96438300, 96442600, GD65D, 3770C, 96404900, 9640490R, 9643580R, 96418800, 96439900, 96418900. 96434900, 96433700, 96433600, ID79CF, ID65CF, S2,000, 96435800, 96435900, B5138CIW, B5138DIW, 96499304, 96453100, 96488300, 96409200, 96456600, 96418400, 96499203, 96499305, 96499809
Manufacturer: INN
Model: Video Slot
Manufacturer: KONAMI
Models: REVOLUTI, KGP2.0UV, KG12.0UR
Manufacturer: Western
Model: TXC/CXC
Manufacturer: WMS
Models: BBU, BB2, BBUR
And others using the F4T5bulb for illumination.
